(19) United States
(12) Patent Application Publication
(10) Pub. No.: US 2013/0339278 A1
(43) Pub. Date: Dec. 19, 2013

(54) DATA DISCRIMINATION DEVICE, METHOD, AND PROGRAM

(71) Applicant: Kenji Aoki, Tokyo (JP)

(72) Inventor: Kenji Aoki, Tokyo (JP)

(73) Assignee: NEC CORPORATION, Tokyo (JP)

(21) Appl. No.: 14/001,709

(22) PCT Filed: Feb. 24, 2012
(86) PCT No.: PCT/JP2012/054579

§ 371 Date: Aug. 27, 2013

(30) Foreign Application Priority Data
Feb. 28, 2011 (JP) 2011-041178

(51) Int. Cl. G06N 99/00

(52) U.S. Cl. CPC G06N 99/005
USPC 706/12

(57) ABSTRACT

A data discrimination device is provided with: an estimating means that estimates the population structure of inputted learning data; a degree-of-fit calculating means that calculates the degree of fit, of each of the inputted addition candidate data, to the population of learning data, using results of the estimation by the estimating means; and a determining means for determining, on the basis of the calculated degree of fit, whether or not to add each of the addition candidate data to the learning data.

### TECHNICAL FIELD

The present invention relates to a data discrimination device for reinforcing learning data, a method therefor, and a program therefor.

### BACKGROUND ART

It is thinkable that when the learning data lacks in machine learning, data thought to resemble the learning data is added to the learning data in order to raise an analysis precision. In general, a determination as to which type of data is suitable as the learning data is heuristically made by persons having specialized knowledge of each field. On the other hand, from a viewpoint of effectiveness of the process, realization of a scheme capable of automatically making a determination as to whether certain data is suitable for the learning data has been desired.

For example, a system for saving any unnecessary term from among terms to be added to teacher data for the machine learning, and adding a term suitable for the teacher data is described in Patent literature 1.

### CITATION LIST

### Patent Literature

PTL 1: JP-P2010-198189A

### SUMMARY OF INVENTION

### Technical Problem

However, the system of the Patent literature 1 is a system of which the field is restricted to a natural language processing field, and application thereof into other various fields is difficult.

When there exists data of additional candidates to the learning data and a determination as to whether the above data is suitable as the learning data is made by the system, the method is thinkable of evaluating whether a prediction precision and a classification precision are improved with an information quantity criterion such as cross-validation before and after adding the data, being additional candidates, to the learning data, and adding data of the above additional candidates to the learning data when the improvement has been ascertained. However, this method makes it possible to evaluate suitableness of an entirety of the additional candidate data; however, the evaluation of the suitableness in a unit of each piece of the data necessitates an enormous computation time of an exponential order for a data size, and is practically difficult to realize.

The present invention has been accomplished in consideration of the above-mentioned problems, and an object of the present invention is to provide a data discrimination device that can efficiently determine whether certain data is suitable for the learning data, a method therefor, and a program therefor.

### Solution to Problem

The present invention is a data discrimination device that is characterized in including an estimating means that estimates a population structure of inputted learning data, a degree-of-fit calculating means that calculates a degree-of-fit to the population of the aforementioned learning data for each piece of inputted addition candidate data using an estimation result by the aforementioned estimating means, and a determining means that determines whether or not to add each piece of the aforementioned addition candidate data to the aforementioned learning data based on the aforementioned calculated degree-of-fit.

The present invention is a data discrimination method that is characterized in estimating a population structure of inputted learning data, calculating a degree-of-fit to the population of the aforementioned learning data for each piece of inputted addition candidate data using the aforementioned estimation result, and determining whether or not to add each piece of the aforementioned addition candidate data to the aforementioned learning data based on the aforementioned calculated degree-of-fit.

The present invention is a program that is characterized in causing a computer to execute an estimating process of estimating a population structure of inputted learning data, a degree-of-fit calculating process of calculating a degree-of-fit to the population of the aforementioned learning data for each piece of inputted addition candidate data using an estimation result by the aforementioned estimating means, and a determining process of determining whether or not to add each piece of the aforementioned addition candidate data to the aforementioned learning data based on the aforementioned calculated degree-of-fit.

### Advantageous Effect of Invention

The present invention makes it possible to efficiently determine whether certain data is suitable for the learning data.

### BRIEF DESCRIPTION OF DRAWINGS

FIG. 1 is a block diagram illustrating a configuration of the data discrimination device related to an exemplary embodiment of the present invention.

FIG. 2 is a flowchart for explaining an operation of the data discrimination device related to the exemplary embodiment of the present invention.

FIG. 3 is a view exemplifying the case in which the learning data has a cluster structure.

### DESCRIPTION OF EMBODIMENTS

Hereinafter, the exemplary embodiment of the present invention will be explained by referencing the accompanied drawings.

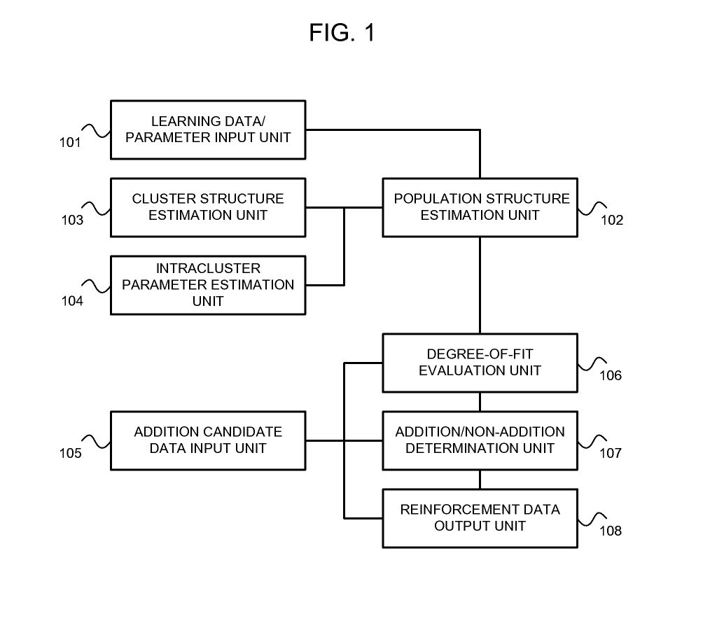

FIG. 1 is a block diagram illustrating a configuration of the data discrimination device related to the exemplary embodiment of the present invention. The data discrimination device, as shown in the figure, includes a learning data/parameter input unit 101, a population structure estimation unit 102, a cluster structure estimation unit 103, an intracluster parameter estimation unit 104, an addition candidate data input unit 105, a degree-of-fit evaluation unit 106, an addition/non-addition determination unit 107, and a reinforcement data output unit 108.

The learning data/parameter input unit 101 receives the input of a learning data X, a cluster number C, a parameter f illustrative of a kind of the degree-of-fit of the addition candidate data. The learning data X is expressed by Equation 1.

[Numerical Equation 1]

X=(x₁, . . . , x_{N})′, xᵢ=(xᵢ₁, . . . xᵢₚ)′ Equation 1

Where, N is a data size of the learning data, p is the sum of a dimension of a criterion variable (normally, 1) and a dimension of an explanatory variable, for example, in a case of processing a prediction problem with a regression analysis, and a dimension of the explanatory variable in a case of processing a discrimination problem. The so-called kind f of the degree-of-fit corresponds to a kind of the method of calculating the degree-of-fit. The method of calculating the degree-of-fit includes, for example, a first calculation method and a second calculation method shown next.

The first calculation method employs a k-means method as the clustering method, obtains a Euclidean distance between an average value of X within the cluster and the addition candidate data for each cluster, and calculates the minimum value, out of these Euclidean distances, as the degree-of-fit.

The second calculation method employs a mixture normal distribution model as the clustering method, obtains a product of a likelihood of the addition candidate data and a mixture ratio for each element distribution, and defines the maximum value, out of these values, as the degree-of-fit.

In a case of processing the problem of a classification to G groups, the learning data expressed by the Equation 1 and a set (Xⱼ, Cⱼ) (j=1, . . . , G) of the clusters of which the number is G are generally inputted; however, in the following, it is assumed that the number of the groups of the inputted data is 1 (one) in order to avoid complexity of the symbol. Thus, (X, C) and f are inputted. The learning data/parameter input unit 101 inputs the learning data X, the cluster number C, the kind f of the degree-of-fit into the parent population structure estimation unit 102.

The parent population structure estimation unit 102 estimates (calculates) various parameters such as the average and the variance of the learning data using the intracluster parameter estimation unit 104 when the number C of the clusters is 1 (one) and estimates (calculates) the cluster structure of the learning data X and the parameter of each cluster using both of the cluster structure estimation unit 103 and the intracluster parameter estimation unit 104 when the number C of the clusters is 2 or more in terms of the learning data X, the cluster number C, the kind f of the degree-of-fit inputted by the learning data/parameter input unit 101. The calculated parameter of each cluster is inputted into the degree-of-fit evaluation unit 106.

The cluster structure estimation unit 103 and the intracluster parameter estimation unit 104 specifically estimate (calculate) the population structure of the learning data. Herein, the parameters that are estimated with regard to the first calculation method and the second calculation method described before will be explained.

In the first calculation method, the cluster structure estimation unit 103 and the intracluster parameter estimation unit 104 obtain an average value μₖ (k=1, . . . , C) of each cluster using the k-means method under a condition in which the learning data X and the cluster number C have been given, and output it to the degree-of-fit evaluation unit 106. When a Mahalanobis distance is used instead of the Euclidean distance, the cluster structure estimation unit 103 and the intracluster parameter estimation unit 104 also output a variance-covariance matrix Σₖ (k=1, . . . , C) of each cluster.

Additionally, an algorithm of the k-means method is described, for example, in chapter 2 of “MIYAMOTO Sadaaki, An Introduction to Cluster Analysis—Theory and Application of Fuzzy Clustering”, Morikita Publishing Co., Ltd., October, 1990.

In the second calculation method, the cluster structure estimation unit 103 and the intracluster parameter estimation unit 104 obtain an average value μₖ (k=1, . . . , C), a variance-covariance matrix Σₖ (k=1, . . . , C), and a mixture ratio π (k=1, . . . , C) of each element distribution (probability distribution) with an EM algorithm, and outputs them to the degree-of-fit evaluation unit 106.

Additionally, the EM algorithm is described, for example, in chapter 5 of “Kenichi Kanatani, Basic Optimization Mathematics—from Basic Principle to Calculation Method”, Kyoritsu Shuppan Co., Ltd., September, 2005.

The addition candidate data input unit 105 receives the input of addition candidate data Y (Equation 2) of which utilization as the learning data is evaluated, and a threshold θ for the degree-of-fit, being a reference for determining whether or not the addition candidate data is added to the learning data.

[Numerical Equation 2]

Y=(y₁, . . . , y_{M})′, yᵢ=(yᵢ₁, . . . yᵢₚ)′ Equation 2

Where, M is a data size of the addition candidate data.

The addition candidate data input unit 105 inputs the addition candidate data Y into the degree-of-fit evaluation unit 106, and inputs the threshold θ into the addition/non-addition determination unit 107.

The degree-of-fit evaluation unit 106 estimates (calculates) a degree-of-fit gᵢ for the addition candidate data Y using the parameter provided by the population structure estimation unit 102. The degree-of-fit to be calculated corresponds to the kind f of the degree-of-fit inputted by the learning data/parameter input unit 101. The degree-of-fit evaluation unit 106 inputs the obtained degree-of-fit gᵢ into the addition/non-addition determination unit 107.

Herein, the degrees-of-fit to be calculated based on the first calculation method and the second calculation method described before will be explained respectively.

With the case of the first calculation method, the degree-of-fit evaluation unit 106 calculates the degree-of-fit gᵢ shown next for each yᵢ (i=1, . . . , M). The case of using the Euclidean distance is shown in Equation 3, and case of using the Mahalanobis distance is shown in Equation 4. In this case, as the distance (the degree-of-fit) becomes smaller, the addition candidate data is fitted into the population all the more.

[Numerical Equation 3]

gᵢ=^{min}_{k-1, . . . , C}(yᵢ−μₖ)′(yᵢ−μₖ) Equation 3

[Numerical Equation 4]

gᵢ=^{min}_{k-1, . . . , C}(yᵢ−μₖ)′Σ⁻¹ₖ(yᵢ−μₖ) Equation 4

With the case of the second calculation method, the degree-of-fit evaluation unit 106 calculates the degree-of-fit gᵢ shown in Equation 5 for each yᵢ. In this case, as the likelihood (the degree-of-fit) becomes larger, the addition candidate data is fitted into the population all the more.

[Numerical Equation 5]

gᵢ=^{max}_{k-1, . . . , C}πₖN(yᵢ|μₖ, Σₖ) Equation 5

Where, N (yᵢ|μₖ, Σkₖ) is a likelihood of yᵢ to a p-dimension normal distribution of the average μₖ and the variance Σₖ.

The addition/non-addition determination unit 107 determines the addition candidate data of which the degree-of-fit has a value equal to or more than (or equal to or less than) the threshold θ by employing the threshold θ provided by the addition candidate data input unit 105 and the degree-of-fit gᵢ (i=1, . . . , M) provided by the degree-of-fit evaluation unit 106, generates an index of a determination result, and inputs it into the reinforcement data output unit 108. For example, the addition/non-addition determination unit 107 may determine the data of which the degree-of-fit is equal to or less than the threshold as data to be added to the learning data with the case in which the degree-of-fit is obtained by the first calculation method, and may determine the data of which the degree-of-fit is equal to or more than the threshold as data to be added to the learning data with the case in which the degree-of-fit is obtained by the second calculation method.

Upon receipt of the index of the data determined as data to be added to the learning data, out of the addition candidate data, from the addition/non-addition determination unit 107, the reinforcement data output unit 108 outputs it.

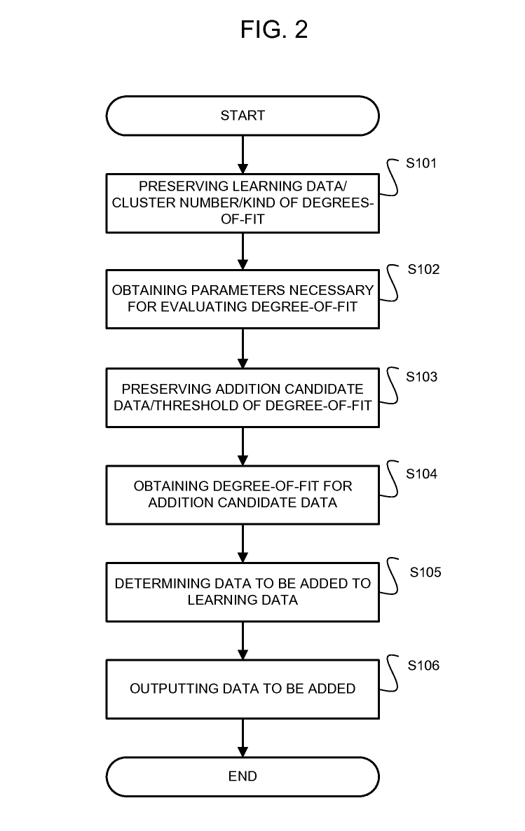

Next, an operation of the data discrimination device related to this exemplary embodiment will be explained by referencing a flowchart of FIG. 2.

The learning data/parameter input unit 101 receives the input of the learning data X, the cluster number C, the parameter f illustrative of the kind of the degree-of-fit of the addition candidate data, and preserves them in a storage region (Step S101).

The population structure estimation unit 102 calculates the parameters (the average etc. of each cluster) necessary for evaluating the degree-of-fit from the preserved (X, C) and f (Step S102).

The addition candidate data input unit 105 receives the input of the addition candidate data Y and the threshold θ, being a reference for determining addition/non-addition of the addition candidate data, and preserves them in a storage region (Step S103).

The degree-of-fit evaluation unit 106 calculates the degree-of-fit gᵢ for each addition candidate data yᵢ (i=1, . . . , M) (Step S104).

The t addition/non-addition determination unit 107 determines the data that is added to the learning data from the threshold θ and the degree-of-fit gᵢ (Step S105).

The reinforcement data output unit 108 outputs the data determined as data to be added to the learning data (Step S106).

The present invention employs goodness of fit (the degree-of-fit) to the population structure to be estimated from the learning data as a reference for evaluating appropriateness of the addition candidate data as the learning data. In the above-mentioned exemplary embodiment, only the addition candidate pieces of the data having the degree-of-fit equal to or more than (or equal to or less than) the pre-set threshold are added to the learning data; however, only high-ranked pieces of the data, namely, a certain percent of pieces of the data over a pre-set ratio in a descending order of the degree-of-fit, to begin with the piece of the data of which the degree-of-fit is largest (or in an ascending order, to begin with the piece of the data of which the degree-of-fit is smallest), out of the addition candidate pieces of the data, may be added. The degree-of-fit includes, for example, a distance (Euclidean distance, Mahalanobis distance, Humming distance, and the like) from a representative value (an average, a median, a mode, and the like). Further, a probability model may be supposed for the population structure of the learning data to define the likelihood of the addition candidate data to the probability model estimated from the learning data as the degree-of-fit.

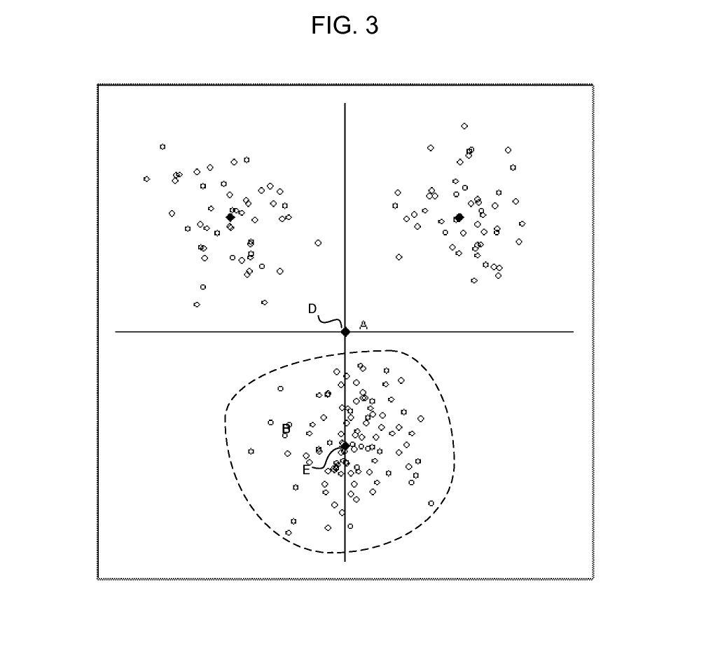

Further, with the case in which the learning data has a cluster structure, this exemplary embodiment obtains a representative value of the nearest cluster for each piece of the addition candidate data, and defines a distance from the above representative value as the degree-of-fit. The reason is that with the case in which the learning data has a cluster structure, simply computing a distance from a representative value of an entirety of the learning data cause a possibility that the appropriate evaluation cannot be made. An example of the case in which the learning data has a cluster structure is shown in FIG. 3. In FIG. 3, it is assumed that a point D is an average of an entirety of the learning data, and a point A is nearer to the point D when the point A is compared with a point B; however, it is the point B that is suitable as the learning data. The reason why the point B is more suitable as the learning data is that a distance between a point E, being a representative value of the learning data encircled by dotted lines and the point B is not so remote as compared with a dispersion of the learning data encircled by dotted lines. Similarly to the case of supposing the probability model for the population structure of the learning data, this exemplary embodiment supposes a poly-modal distribution such as a mixture distribution model, computes, for example, a product of the likelihood to the element distribution and the mixture ration for each element distribution with the case of the mixture distribution model, and defines the largest value, out of them, as the degree-of-fit.

As explained above, the present invention makes it possible to efficiently determine whether or not to add the addition candidate data of the learning data to the learning data using the degree-of-fit of the addition candidate data to the learning data. Further, an entirety of the addition candidate date can be evaluated at a computation time in a linear order for the data size because the degree-of-fit can be evaluated independently for each piece of the data within the addition candidate data.

Additionally, the data discrimination device may be configured of, for example, an input device, a controller such as CPU, a storage device, a display device, a computer provided with a communication controller, and the like. The learning data/parameter input unit 101, the population structure estimation unit 102, the cluster structure estimation unit 103, the intracluster parameter estimation unit 104, the addition candidate data input unit 105, the degree-of-fit evaluation unit 106, the addition/non-addition determination unit 107, and the reinforcement data output unit 108 of the data discrimination device related to the above-described exemplary embodiment of the present invention may be realized by reading out and executing an operational program stored in the storage device by the CPU, and further, they may be configured with hardware. In this case, functions and operations similar to the functions and the operations of the above-described exemplary embodiment are realized by a processor that operates under a program stored in a program memory. Only one part of the above-described functions of the exemplary embodiment can be realized with the computer program.

Above, while the present invention has been particularly shown and described with reference to preferred exemplary embodiment, the present invention is not limited to the above mentioned exemplary embodiment. It will be understood by those of ordinary skill in the art that various changes in form and details may be made therein without departing from the spirit and scope of the present invention.

An entirety or one part of the learning data X, the cluster number C and the kind f of the degree-of-fit to be inputted into the learning data/parameter input unit 101, and the addition candidate data Y and the threshold θ to be inputted into the addition candidate data input unit 105 may be inputted from the outside of this device, and may be read out from the storage device that this device includes and inputted.

One part or an entirety of the above exemplary embodiment can be expressed as the following notes, but the invention is not limited thereto.

(Supplementary Note 1)

A data discrimination device, including:

an estimating means that estimates a population structure of inputted learning data;

a degree-of-fit calculating means that calculates a degree-of-fit to the population of the aforementioned learning data for each piece of inputted addition candidate data using an estimation result by the aforementioned estimating means; and

a determining means that determines whether or not to add each piece of the aforementioned addition candidate data to the aforementioned learning data based on the aforementioned calculated degree-of-fit.

(Supplementary Note 2)

The data discrimination device according to the supplementary note 1:

wherein the aforementioned estimating means estimates the population structure for each cluster when the aforementioned learning data has a cluster structure; and

wherein the aforementioned degree-of-fit calculating means calculates the degree-of-fit to the aforementioned each cluster for each piece of the aforementioned addition candidate data, and selects one optimum degree-of-fit from the calculated degrees-of-fit when the aforementioned learning data has the cluster structure.

(Supplementary Note 3)

The data discrimination device according to the supplementary note 1 or the supplementary note 2, wherein the aforementioned degree-of-fit calculating means calculates a distance with a representative value of the aforementioned learning data as the aforementioned degree-of-fit for each piece of the aforementioned addition candidate data.

(Supplementary Note 4)

The data discrimination device according to the supplementary note 1 or the supplementary note 2, wherein the aforementioned degree-of-fit calculating means calculates a likelihood to a probability distribution of the aforementioned learning data as the aforementioned degree-of-fit for each piece of the aforementioned addition candidate data.

(Supplementary Note 5)

A data discrimination method including:

estimating a population structure of inputted learning data;

calculating a degree-of-fit to the population of the aforementioned learning data for each piece of inputted addition candidate data using the aforementioned estimation result; and

determining whether or not to add each piece of the aforementioned addition candidate data to the aforementioned learning data based on the aforementioned calculated degree-of-fit.

(Supplementary Note 6)

The data discrimination method according to the supplementary note 5, including:

estimating the population structure for each cluster when the aforementioned learning data has a cluster structure in estimation of the aforementioned population structure; and

calculating the degree-of-fit to the aforementioned each cluster for each piece of the aforementioned addition candidate data, and selecting one optimum degree-of-fit from the calculated degrees-of-fit when the aforementioned learning data has the cluster structure in calculation of the aforementioned degree-of-fit.

(Supplementary Note 7)

The data discrimination method according to the supplementary note 5 or the supplementary note 6, including calculating a distance with a representative value of the aforementioned learning data as the aforementioned degree-of-fit for each piece of the aforementioned addition candidate data in calculation of the aforementioned degree-of-fit.

(Supplementary Note 8)

The data discrimination method according to the supplementary note 5 or the supplementary note 6, including calculating a likelihood to a probability distribution of the aforementioned learning data as the aforementioned degree-of-fit for each piece of the aforementioned addition candidate data in calculation of the aforementioned degree-of-fit.

(Supplementary Note 9)

A program causing a computer to execute:

an estimating process of estimating a population structure of inputted learning data;

a degree-of-fit calculating process of calculating a degree-of-fit to a population of the aforementioned learning data for each piece of inputted addition candidate data using an estimation result by the aforementioned estimating means; and

a determining process of determining whether or not to add each piece of the aforementioned addition candidate data to the aforementioned learning data based on the aforementioned calculated degree-of-fit.

(Supplementary Note 10)

The program according to the supplementary note 9:

wherein the aforementioned estimating process estimates the population structure for each cluster when the aforementioned learning data has a cluster structure; and

wherein the aforementioned degree-of-fit calculating process calculates the degree-of-fit to the aforementioned each cluster for each piece of the aforementioned addition candidate data, and selects one optimum degree-of-fit from the calculated degrees-of-fit when the aforementioned learning data has the cluster structure.

(Supplementary Note 11)

The program according to the supplementary note 9 or the supplementary note 10, wherein the aforementioned degree-of-fit calculating process calculates a distance with a representative value of the aforementioned learning data as the aforementioned degree-of-fit for each piece of the aforementioned addition candidate data.

(Supplementary Note 12)

The program according to the supplementary note 9 or the supplementary note 10, wherein the aforementioned degree-of-fit calculating process calculates a likelihood to a probability distribution of the aforementioned learning data as the aforementioned degree-of-fit for each piece of the aforementioned addition candidate data.

Above, while the present invention has been particularly shown and described with reference to preferred exemplary embodiment, the present invention is not limited to the above mentioned exemplary embodiment. It will be understood by those of ordinary skill in the art that various changes in form and details may be made therein without departing from the spirit and scope of the present invention.

This application is based upon and claims the benefit of priority from Japanese patent application No. 2011-041178, filed on Feb. 28, 2011, the disclosure of which is incorporated herein in its entirety by reference.

### REFERENCE SIGNS LIST

101 learning data/parameter input unit

102 population structure estimation unit

103 cluster structure estimation unit

104 intracluster parameter estimation unit

105 addition candidate data input unit

106 degree-of-fit evaluation unit

107 addition/non-addition determination unit

108 reinforcement data output unit

1. A data discrimination device, comprising:
an estimating unit that estimates a population structure of inputted learning data;
a degree-of-fit calculating unit that calculates a degree-of-fit to the population of said learning data for each piece of inputted addition candidate data using an estimation result by said estimating unit; and
a determining unit that determines whether or not to add each piece of said addition candidate data to said learning data based on said calculated degree-of-fit.

2. The data discrimination device according to claim 1:
wherein said estimating unit estimates the population structure for each cluster when said learning data has a cluster structure; and
wherein said degree-of-fit calculating unit calculates the degree-of-fit to said each cluster for each piece of said addition candidate data, and selects one optimum degree-of-fit from the calculated degrees-of-fit when said learning data has the cluster structure.

3. The data discrimination device according to claim 1, wherein said degree-of-fit calculating unit calculates a distance with a representative value of said learning data as said degree-of-fit for each piece of said addition candidate data.

4. The data discrimination device according to claim 1, wherein said degree-of-fit calculating unit calculates a likelihood to a probability distribution of said learning data as said degree-of-fit for each piece of said addition candidate data.

5. A data discrimination method, comprising:
estimating a population structure of inputted learning data;
calculating a degree-of-fit to the population of said learning data for each piece of inputted addition candidate data using said estimation result; and
determining whether or not to add each piece of said addition candidate data to said learning data based on said calculated degree-of-fit.

6. A non-transitory computer readable storage medium storing a program causing a computer to execute:
an estimating process of estimating a population structure of inputted learning data;
a degree-of-fit calculating process of calculating a degree-of-fit to the population of said learning data for each piece of inputted addition candidate data using an estimation result by said estimating process; and
a determining process of determining whether or not to add each piece of said addition candidate data to said learning data based on said calculated degree-of-fit.

7. The data discrimination method according to claim 5, comprising:
estimating the population structure for each cluster when the aforementioned learning data has a cluster structure in estimation of the aforementioned population structure; and
calculating the degree-of-fit to the aforementioned each cluster for each piece of the aforementioned addition candidate data, and selecting one optimum degree-of-fit from the calculated degrees-of-fit when the aforementioned learning data has the cluster structure in calculation of the aforementioned degree-of-fit.

8. The data discrimination method according to claim 5, comprising:
calculating a distance with a representative value of the aforementioned learning data as the aforementioned degree-of-fit for each piece of the aforementioned addition candidate data in calculation of the aforementioned degree-of-fit.

9. The data discrimination method according to claim 5, comprising:
calculating a likelihood to a probability distribution of the aforementioned learning data as the aforementioned degree-of-fit for each piece of the aforementioned addition candidate data in calculation of the aforementioned degree-of-fit.

10. The non-transitory computer readable storage medium according to claim 6:
wherein the aforementioned estimating process estimates the population structure for each cluster when the aforementioned learning data has a cluster structure; and
wherein the aforementioned degree-of-fit calculating process calculates the degree-of-fit to the aforementioned each cluster for each piece of the aforementioned addition candidate data, and selects one optimum degree-of-fit from the calculated degrees-of-fit when the aforementioned learning data has the cluster structure.

11. The non-transitory computer readable storage medium according to claim 6:
wherein the aforementioned degree-of-fit calculating process calculates a distance with a representative value of the aforementioned learning data as the aforementioned degree-of-fit for each piece of the aforementioned addition candidate data.

12. The non-transitory computer readable storage medium according to claim 6:
wherein the aforementioned degree-of-fit calculating process calculates a likelihood to a probability distribution of the aforementioned learning data as the aforementioned degree-of-fit for each piece of the aforementioned addition candidate data.
